(19) United States
(12) Patent Application Publication
(10) Pub. No.: US 2006/0218729 A1
(43) Pub. Date: Oct. 5, 2006

(54) Method for making environment-friendly artificial leather from ultra micro fiber without solvent treatment

(75) Inventors: Chung-Chih Feng, Sanmin (TW); Kuo-Kuang Cheng, Daliao Shiang (TW); Jong-Shy Lin, Dashe Shiang (TW); Chun-Hsien Lee, Sanmin (TW)

Correspondence Address: NIKOLAI & MERSEREAU, P.A., 900 SECOND AVENUE SOUTH, SUITE 820, MINNEAPOLIS, MN, 55402, US

(73) Assignee: SAN FANG CHEMICAL INDUSTRY CO., LTD., Jenwu Shiang (TW)

(21) Appl. No.: 11/241,454

(22) Filed: Sep. 29, 2005

(30) Foreign Application Priority Data
Mar. 30, 2005 (TW) 094110148

(51) Int. Cl. C14C 1/00

(52) U.S. Cl. 8/94.15

(57) ABSTRACT

There is disclosed a method for making environment-friendly artificial leather from ultra micro fiber without solvent treatment. The method includes the step of making at least two components into ultra micro fibers, as raw materials, by means of conjugate spinning. By means of spun lacing or water lacing, three-dimensional interlacing is conducted on the ultra micro fibers in order to provide non-woven fabric, as a substrate. After the substrate is impregnated with water-borne resin solution, salt solution is used to solidify the water-borne resin solution in the substrate. The sea component of the ultra micro fibers is removed by means of alkaline. Abrading and finishing are conducted in order to obtain a semi-product of the environment-friendly artificial leather. The semi-product is dyed or water-borne resin is adhered to the semi-product in order to provide the environment-friendly artificial leather made from the ultra micro fibers without solvent treatment, providing a leather-like feel and excellent softness and physical properties.

### BACKGROUND OF INVENTION

1. Field of Invention

The present invention relates to a method for making environment-friendly artificial leather from ultra micro fibers without solvent treatment.

2. Related Prior Art

In U.S. Pat. No. 3,531,368, there is disclosed a method for making chammy-imitating artificial leather from micro fibers. Non-woven fabric is made of composite fibers that include an island portion of nylon and a sea portion of cationic dyeable polyesters (“CD-PET”). The non-woven fabric is submerged in polyurethane (“PU”) resin in which Dimethylformamide (“DMF”) is dissolved. Curing is done in DMF solution. Washing and drying are conducted. The sea portion of CD-PET is removed. Finally, the polyurethane resin is polished and finished in order to provide the artificial leather. Although artificial leather can be made according to this conventional method, too much solvent such as DMF is used and recycled. Hence, this method is not environment-friendly and demands intense labor.

Moreover, in EPO Patent No. 1041191, water-borne PU emulsion is used instead of the PU resin in which DMF or other organic solvent is dissolved, in order to soak the non-woven fabric of the duo-component (or “sea-island type”) fibers. After the sea portion of the fibers is removed, the PU resin is polished and finished. Thus, there is made artificial leather free of DMF solvent. The primary problem of this EPO patent is that emulsion tends to migration so that the PU migrates to two sides of the non-woven fabric, i.e., the PU is distributed uneven in the non-woven fabric. Hence, the artificial leather exhibits poor feel and physical properties and, more particularly, wear-resistance.

In Japanese Patent Application Publication No. 55-051076, there is disclosed a method for making artificial leather by means of heating non-woven fabric of highly contractible polyester fibers. The non-woven fabric of the highly contractible polyester fibers is submerged in thermo-sensitive water-borne polymer. The polymer is cured, polished and finished. The primary problem of this Japanese patent application is that the water-borne polymer migrates, i.e., the PU is distributed unevenly in the artificial leather so that the artificial leather exhibits poor bend-resistance and large wrinkles. Furthermore, the contraction of the fibers and the thermo-sensitive curing of the water-borne PU require two heating processes that consume much energy and results in a high cost.

The present invention is therefore intended to obviate or at least alleviate the problems encountered in prior art.

### SUMMARY OF INVENTION

According to the present invention, a method for making artificial leather without solvent treatment includes the steps of providing a substrate of non-woven fabric made of sea-island ultra micro fibers, submerging the substrate in water-borne resin solution, curing the water-borne resin in the substrate by means of brine, removing the sea portion from the sea-island fibers of the substrate by means of alkaline solution, and finishing.

An advantage of the method according to the present invention is to provide the semi-product in an environment-friendly manner, mainly for not involving solvent treatment and not consuming much energy.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is a block diagram of a method for making artificial leather without solvent treatment according to the preferred embodiment of the present invention.

FIG. 2 shows the microstructure of a semi-product of the artificial leather made in the method shown in FIG. 1.

FIG. 3 shows the microstructure of another semi-product of the artificial leather made in the method shown in FIG. 1.

FIG. 4 shows a used in the semi-product shown in FIG. 3.

### DETAILED DESCRIPTION OF PREFERRED EMBODIMENT

After quite some time of intense study, the applicant of the present application has found that assistant agent can be added to water-borne resin (generally water-borne PU) in order to improve the heat-resistance of the water-borne resin. Hence, in a heating process of a method for making artificial leather, at a normal temperature, the vaporization of the water-borne resin is expedited, and the viscosity of the water-borne resin is increased, and the binding force between the water-borne resin and fibers of a sea-island type is increased. The migration of the water-borne resin is reduced. Hence, the physical properties of the resultant artificial leather are improved. In drying the water-borne resin and removing the sea portion from the fibers, microwave can be provided in order to reduce the migration of the water-borne resin. In a method for making artificial leather according to the present invention, no DMF solvent is used, thus avoiding problems of high costs related to labor and environmental protection in recycling of DMF solvent.

In the method for making artificial leather without solvent treatment according to the present invention, three-dimensional interlacing of ultra micro fibers of a sea-island type of a non-woven fabric is done by means of needling or spun-lacing, and is submerged in water-borne resin added with assistant agent. The water-borne resin is cured in brine. The sea portion of the fibers is dissolved in alkaline solution. Washing and drying are conducted. Polishing is conducted in order to provide a semi-product of the artificial leather. To provide the final product, the semi-product is dyed, or water-borne PU is adhered to the semi-product.

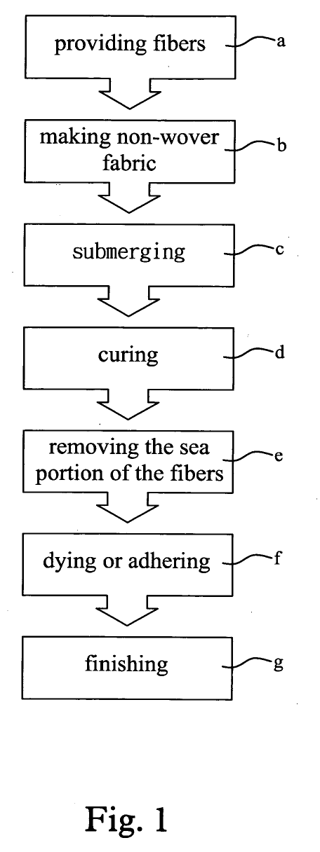

Referring to FIG. 1, there is shown a method for making artificial leather without solvent treatment according to the preferred embodiment of the present invention.

The method includes several steps. Firstly, there are provided ultra micro fibers (1 to 10 deniers) of a sea-island type that consists of at least two portions.

Secondly, by means of needling or spun-lacing, three-dimensional interlacing of the ultra micro fibers is done in order to provide non-woven fabric.

Thirdly, the non-woven fabric is submerged in water-borne elastomer solution added with assistant agent.

Fourthly, the water-borne elastomer is cured in brine.

Fifthly, the sea portion of the fibers is dissolved in alkaline solution and removed from the fibers.

Sixthly, the water-borne elastomer is polished in order to provide a semi-product of the artificial leather.

Finally, to provide the artificial leather, the semi-product is dyed, or water-borne PU is adhered to the semi-product.

The ultra micro fibers include a duo-component structure and, more particularly, sea-island type consisting of at least two portions, i.e., a sea portion and at least one island portion. The fibers can be made from any polymers that can form fibers. For example, polyamide polymers, polyester polymers, polyacrylonitrile polymers, polyaminoester polymers and polyolefine polymers can be used. Polymers of different families are used such as a polyamide polymer used with a polyester polymer, a polyamide polymer used with a polyolefine polymer, and a polyester polymer used with a polyolefine polymer. Two polymers with different degrees of polymerization of a same family can be used; however, the use of polymers of different compositions is important and complementary. By means of conjugate spinning, the polymers of different components are made into the fibers of the non-woven fabric.

The at least two polymers are made into the ultra micro fibers such as the sea-island type or a split type. By means of needling or spun-lacing of 200 to 2500 stitch/cm², with or without a net, the duo-component fibers are made into the non-woven fabric used as a substrate. Should it be less than 200 stitch/cm², the three-dimensional interlacing of the fibers would not be done. Should it be more than 2500 stitch/cm², the three-dimensional interlacing of the fibers would be too dense so that the resultant artificial leather would be too hard and too non-elastic.

The substrate is submerged in 5% polyvinyl alcohol (“PVA”) and dried. Furthermore, the water-borne resin, such as water-borne PU resin, is mixed with water and added with assistant agent in order to provide water-borne PU resin solution. The water-borne resin is 10%%_{wt} to 65%_{wt} (based on the solid content) and, more preferably 25%_{wt} to 40%_{wt} of the water-borne resin solution. The assistant agent is 0.5%%_{wt} to 5%%_{wt} of the water-borne resin solution. The assistant agent is used to improve the heat-resistance of the water-borne PU solution so that water can be vaporized quickly so that the viscosity of the water-borne PU resin gets higher, thus reducing the migration and increasing the binding force between the PU resin and the fibers in order to upgrade the physical properties of the product. The assistant agent could be hydrazine, benzotriazole and formamidine (ultra-violet absorber), phenol-acrylate (heat-resistant agent and process stabilizer), hindered phenol, amide, sulfur and phosphor. Should the percentage be lower than 0.5%_{wt}, the water of the water-borne PU solution would be vaporized quickly but the water-borne PU solution would migrate. Should the percentage is higher than 5%_{wt}, the situation would be to the contrary. The absorbed water-borne resin solution is 0.5 to 4.5 times as heavy as the substrate. Should it be less than 0.5, the water-borne resin is inadequate to form artificial leather with body hand feel. Should it be greater than 4.5, the water-borne resin would be too much so that the resultant artificial leather would be too hard and that there would be too much PU on the surface.

After the water-borne resin absorbed by the substrate is cured by means of the brine, the sea portion is removed from the ultra micro fibers. The water-borne resin is polished and finished in order to provide the semi-product of the environment-friendly artificial leather. The semi-product can be dyed or water-borne resin can be adhered to the semi-product so that without solvent treatment, the product is made with a realistic feel, excellent softness and physical properties. There is no special limitation for the manner in which the water-borne resin solution is cured. Yet, the water-borne resin solution is generally submerged in deficient but appetent solvent, and the so-called wet curing process is used in which holes are made when the solvent is dissolved into the curing liquid. In the wet curing process, after the substrate is submerged in water-borne resin solution with a solid content of 25%_{wt} to 40%_{wt} (higher than that of the oil-borne resin solution used in the prior art, 5%_{wt} to 20%_{wt}), it is squeezed by means of squeezing rollers, and cured, and washed, and dried. The salt in the curing liquid for curing the water-borne resin by the substrate may be nitrate, chloride salt and weak acid, taken alone or in combination, and, more preferably, nitrate solution. The drying takes place at 120 to 160 centigrade degrees by means of hot air or microwave.

After the water-borne resin is cured by means of the curing liquid containing the salt, alkaline solution is used to remove the sea portion from the fibers of the substrate. The alkaline solution may be 5%_{wt} to 20%_{wt} sodium hydroxide. After the removal of the sea portion, the fibers are made into fibers of 0.0001 to 0.3 deniers. Then, washing and drying are conducted. The drying takes place at 120 to 160 centigrade degrees by means of hot air or microwave.

After the sea portion is removed by means of the alkaline solution, washing is conducted by means of hot water at 80 to 100 centigrade degrees.

After the washing and the removal of the sea portion of the ultra micro fibers, the polishing and finishing are conducted in order to provide the semi-product of the environment-friendly artificial leather. The water-borne PU is provided on releasing paper. Water-borne adhesive is coated on the water-borne PU so that that the water-borne PU can be adhered to the semi-product.

The semi-product can be dyed using suspend-grind structure to make sheet with silky luster, thus providing the environment-friendly artificial leather that exhibits a realistic feel and excellent softness and physical properties.

An example of the artificial leather made in the method according to the present invention will be described. PU solution without DMF is used.

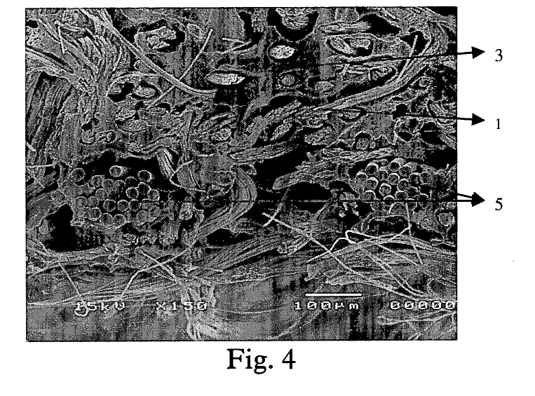

Duo-component ultra micro fibers with a length of 51 mm and a fineness of 3 deniers are made into even cotton webs by means of a carding machine, and the cotton webs are made into a laminate by means of a crosslapper, and the laminate is put in a net with a specific weight of 45 g/m², #10 to #150, as shown in FIG. 4). Then, the fibers are made into a non-woven fabric with a specific weight of 400 g/m² and reinforced by means of a net.

The substrate made of the duo-component ultra micro fibers and reinforced with the net is submerged in 5% PVA and dried. Water-borne PU resin with a solid content of 45% is mixed with water (35:65) and added with 1% of assistant agent in order to provide water-borne PU resin solution. The substrate is submerged in the water-borne PU resin solution. The absorbed PU resin solution is 3.0 times as heavy as the substrate. The absorbed PU resin solution is cured in 15% calcium nitrate. 5% sodium hydroxide is used to remove the sea portion from the fibers. Then, washing is conducted with hot water at 80 to 100 centigrade degrees and dried (the SEM (scanning electron microscope) is as shown in FIG. 3). Polishing is done is by means of a polishing machine. Kneading and crumpling are conducted in order to provide a semi-product including a thickness of 1.25 to 1.30 mm and exhibiting a realistic feel and excellent softness and physical properties. To provide the final product, the semi-product can be dyed, or water-born PU can be adhered to the semi-product. Some of the properties of the final product are listed in Table 1.

Another example of the artificial leather made in the method according to the present invention will be described. PU solution without DMF is used.

Duo-component ultra micro fibers with a length of 51 mm and a fineness of 3 deniers are made into even cotton webs by means of a carding machine, and the cotton webs are made into a laminate by means of a crosslapper, and the laminate is needled into a non-woven fabric with a specific weight of 400 g/m².

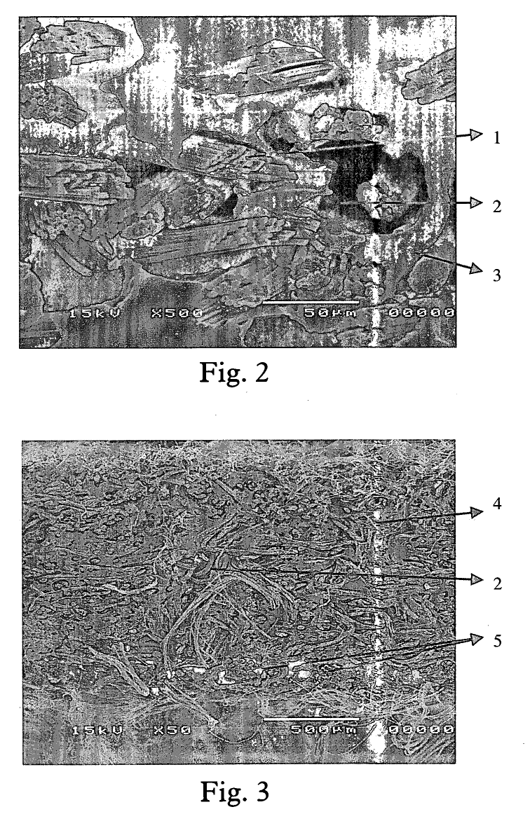

The substrate made of the duo-component ultra micro fibers is submerged in 5% PVA and dried. Water-borne PU resin with a solid content of 45% is mixed with water (35:65) and added with 1% of assistant agent in order to provide water-borne PU resin solution. The substrate is submerged in the water-borne PU resin solution. The absorbed PU resin solution is 3.0 times as heavy as the substrate. The absorbed PU resin solution is cured in 15% calcium nitrate. 5% sodium hydroxide is used to remove the sea portion from the fibers. Washing is conducted with hot water at 80 to 100 centigrade degrees and dried (the SEM is as shown in FIG. 2). Polishing is done by means of a polishing machine. Kneading and crumpling are done in order to provide a semi-product of artificial leather including a thickness of 1.25 to 1.30 mm and exhibiting a realistic feel and excellent softness and physical properties. To make the final product, the semi-product can be dyed, or water-born PU can be adhered to the semi-product. Some of the properties of the final product are listed in Table 1.

An example of the artificial leather made in a conventional method will be described. PU solution with DMF is used.

Duo-component ultra micro fibers with a length of 51 mm and a fineness of 3 deniers are made into even cotton webs by means of a carding machine, and the cotton webs are made into a laminate by means of a crosslapper, and the laminate is stitches into a non-woven fabric with a specific weight of 400 g/m².

The substrate made of the duo-component ultra micro fibers and reinforced with the net is submerged in the water-borne PU resin solution with DMF. The absorbed PU resin solution is 3.8 times as heavy as the substrate. Curing is conducted in 12%_{wt} to 14%_{wt} DMF solution. Then, washing and drying (120 to 140 centigrade degrees) are conducted. 5% sodium hydroxide solution is used to remove the sea portion from the fibers. Then, washing at 80 to 100 centigrade degrees is conducted. Polishing is done is by means of a polishing machine. Kneading and crumpling are done in order to provide a semi-product of artificial leather including a thickness of 1.25 to 1.30 mm and exhibiting a realistic feel and excellent softness and physical properties. To make the final product, PU is adhered to the semi-product. Some of the properties of the final product are listed in Table 1.

Photographs are taken of the examples of the artificial leather made in the method according to the present invention by means of a scanning electronic microscope (SEM, ×500, 50, 150). FIG. 2 shows the structure of the semi-product of the example without a net. FIG. 3 shows the structure of the semi-product of the example with the net. FIG. 4 shows the structure of the net of the semi-product shown in FIG. 3. These drawings are cross-sectional views. The numeral “1” indicates the situation where the sea portion is removed from the fibers by means of the sodium hydroxide solution. The numeral “2” indicates holes made after the sea portion is removed from the composite fibers by means of the sodium hydroxide solution. The numeral “3” indicates the water-borne resin (water-borne PU). The numeral “4” indicates the deployment of the water-borne PU resin and the composite fibers after the sea portion is removed from the composite fibers by means of the sodium hydroxide solution. The numeral “5” indicates the deployment of the net.

The present invention has been described through the detailed illustration of the preferred embodiment. Those skilled in the art can derive variations from the preferred embodiment without departing from the scope of the present invention. Therefore, the preferred embodiment shall not limit the scope of the present invention defined in the claims.

TABLE 1
comparison of two examples of artificial leather of the present invention with a conventional artificial leather

| | | | Extension | Extension | Strength | Strength | Strength against | Strength against | |
|---|---|---|---|---|---|---|---|---|---|
| | | | Rate | Rate | against Tear | against Tear | Peeling | Peeling | |
| Item | Thickness | DMF | T | Y | T | Y | T | Y | |
| (unit) | mm | ppm | % | % | kg | kg | kg/3 cm | kg/3 cm | Hardness |
| Example 1 | 1.26 | 0 | 40 | 98 | 10.5 | 11.8 | 13.5 | 12.5 | 4.3 |
| Example 2 | 1.25 | 0 | 54 | 105 | 9.2 | 8.7 | 15.6 | 13.2 | 4.0 |
| Conventional | 1.28 | 1000 ↑ | 86 | 132 | 9.5 | 8.4 | 14.4 | 11.5 | 4.2 |

| | | | | | | |
|---|---|---|---|---|---|---|
| Test Method | ASTM | USEPA | ASTM | ASTM | ASTM | IUP |
| | D1777 | 5021 | D1117 | D1117 | D2724 | 36 |
| | | 5035A | D1682 | D2262 | | |

What is claimed is:

1. A method for making artificial leather without solvent treatment comprising the steps of:
providing a substrate of non-woven fabric made of sea-island ultra micro fibers;
submerging the substrate in water-borne resin solution;
curing the water-borne resin in the substrate by means of brine;
removing the sea portion from the sea-island fibers of the substrate by means of alkaline solution; and
finishing in order to provide a semi-product of the artificial leather.

2. The method according to claim 1 wherein the water-borne resin solution is water-borne polyurethane resin solution to which 0.5%_{wt} to 5%_{wt} of assistant agent is added in order to improve the heat-resistance thereof.

3. The method according to claim 2 wherein the polyurethane resin is 10%_{wt} to 65%_{wt} of the polyurethane resin solution.

4. The method according to claim 2 wherein the assistant agent is selected from a group consisting of hydrazine, benzotriazole and formamidine, phenol-acrylate, hindered phenol, amide, sulfur and phosphor.

5. The method according to claim 1 wherein the fibers become 0.0001 to 0.3 deniers after the sea portion is removed.

6. The method according to claim 1 comprising the step of:
providing releasing paper;
coating a superficial layer of water-borne polyurethane on the releasing paper; and
coating water-borne adhesive on the superficial layer so that the superficial layer can be adhered to the semi-product and that the releasing paper can be removed from the superficial layer in order to provide the final product of the artificial leather.

7. The method according to claim 1 wherein the semi-product of the artificial leather is dyed and using suspend-grind structure to make sheet with silky luster in order to provide chammy-imitating artificial leather.

8. The method according to claim 1 wherein the semi-product comprises 20% to 60% water-borne resin and 80% to 40% fibers with fineness of 0.0001 to 0.3 deniers.

9. A method for making artificial leather without solvent treatment comprising the steps of:
providing a substrate of non-woven fabric made of sea-island ultra micro fibers;
providing water-borne resin solution;
adding assistant agent to the water-borne resin solution in order to improve the heat-resistance thereof;
submerging the substrate in the water-borne resin solution to which the assistant agent is added;
drying the substrate after the submission;
curing the water-borne resin in the substrate by means of brine;
removing the sea portion from the sea-island fibers of the substrate by means of alkaline solution; and
finishing in order to provide a semi-product of the artificial leather.

10. The method according to claim 9 wherein the water-borne resin solution is water-borne polyurethane resin solution.

11. The method according to claim 10 wherein the water-borne polyurethane resin is 10%_{wt} to 65%_{wt} of the water-borne polyurethane resin solution.

12. The method according to claim 9 wherein the assistant agent is 0.5%_{wt} to 5%%_{wt} of the water-borne resin solution.

13. The method according to claim 9 wherein the assistant agent is selected from a group consisting of hydrazine, benzotriazole and formamidine, phenol-acrylate, hindered phenol, amide, sulfur and phosphor.

14. The method according to claim 9 wherein the fibers become 0.0001 to 0.3 deniers after the sea portion is removed.

15. The method according to claim 9 comprising the step of:
providing releasing paper;
coating a superficial layer of water-borne polyurethane on the releasing paper; and
coating water-borne adhesive on the superficial layer so that the superficial layer can be adhered to the semi-product and that the releasing paper can be removed from the superficial layer in order to provide the final product of the artificial leather.

16. The method according to claim 9 wherein the semi-product of the artificial leather is dyed and using suspend-grind structure to make sheet with silky luster in order to provide chammy-imitating artificial leather.

17. The method according to claim 9 wherein the semi-product comprises 20% to 60% water-borne resin and 80% to 40% fibers with fineness of 0.0001 to 0.3 deniers.

18. The method according to claim 9 wherein the step of drying the substrate comprises the step of providing microwave for drying the substrate at 120 to 160 centigrade degrees.
